(19) United States
(12) Patent Application Publication
(10) Pub. No.: US 2009/0014613 A1
(43) Pub. Date: Jan. 15, 2009

(54) Swimming pool hook

(76) Inventors: Jacqueline Szymczak, Euless, TX (US); John D. Szymczak, Euless, TX (US)

Correspondence Address: LYNN E BARBER, P O BOX 16528, FORT WORTH, TX, 76162, US

(21) Appl. No.: 11/827,114

(22) Filed: Jul. 10, 2007

(51) Int. Cl. F16B 45/00

(52) U.S. Cl. 248/304

(57) ABSTRACT

A swimming pool hook having a first end (lower bend) with a short extension and a second end (upper bend) with a handle extension.

### BACKGROUND OF THE INVENTION

1. Field of the Invention

This invention relates to swimming pool maintenance, and in particular, relates to a pool hook for removal of pool skimmer covers.

2. Description of the Related Art

Backyard swimming pools typically have at least one skimmer to keep the water surface free from debris. Water from the pool circulates through the pool skimmer and debris entering the skimmer remains there as the water passes through the skimmer. So that the skimmer does not become clogged, the debris that collects in the skimmer is periodically removed by pool servicing personnel or the pool owner, who must remove the skimmer cover from the top of the skimmer to access the inside of the skimmer. Because the skimmer's functionality requires that it be located at or near the surface of the water in the pool, this means that the personnel who service the pool must bend down and/or reach down to grasp and remove the skimmer cover. Skimmer covers typically fit tightly on the skimmers so that it is difficult to use one's fingers to pull the skimmer cover off the skimmer, and in some cases the cover can cut the person's fingers or can be too hot to touch comfortably. The skimmer cover is often difficult to remove because pf expansion of the ground or ground movement. For new pools or renovated pools, sand that is put on new mastic that seals the crack between the coping and deck of the pool accumulates to impede opening of the skimmer cover. In addition, pool servicing personnel often encounter various rodents, reptiles, amphibians and other wildlife that have become trapped in or on the skimmer, so that it may be dangerous or unpleasant to reach in the skimmer with one's bare hands.

In addition, pool owners often have need to hang various pool accessories, such as nets, brushes, and telescoping poles the like on a fence or wall near the pool.

A prior pool hook that has a complicated structure is made by Pool Tool Company (Ventura, Calif.), and is a rounded cap that can be screwed on to a tile brush handle/pole with a hook that sticks out of the cap that may be used to remove skimmer covers and baskets.

It is therefore an object of the invention to provide an inexpensive lightweight pool hook that allows pool servicing personnel to remove the cover from a pool skimmer without bending down and without coming into direct contact with the debris before being sure that it is safe to do so. The pool hook of the invention also allows the personnel to poke around skimmer baskets, loosening materials in the skimmer basket while the pool is running, and then lift the skimmer basket out. It is a further object of the invention to provide a pool hook that easily engages or disengages the cover of a pool skimmer. It is a further object of the invention to provide a pool hook that may also be used to hang other pool accessories from a vertical surface. It is a further object of the invention to provide a pool hook that may also be used to retrieve pool cleaner hoses from the pool so that the cleaner bag may be emptied, to check out the pool cleaner, and the like.

Other objects and advantages will be more fully apparent from the following disclosure and appended claims.

### SUMMARY OF THE INVENTION

The invention herein is a swimming pool hook having a first end with a short hook and a second end with an extended hook for removing skimmer covers.

Other objects and features of the inventions will be more fully apparent from the following disclosure and appended claims.

### BRIEF DESCRIPTION OF THE DRAWINGS

FIG. 1 is a perspective view of a first embodiment of the pool hook of the invention having a square cross-section.

FIG. 2 is a perspective view of a second embodiment of the pool hook of the invention having a circular cross-section.

FIG. 3 is a perspective view of the pool hook of the invention in which both ends are bent in the same direction.

FIG. 4 is a partial elevational side view of the upper bend of the pool hook of the invention having a round cross-section.

FIG. 5 is a partial elevational side view of the lower bend of the pool hook of the invention having a square cross-section and having an end surface generally planar to the elongate shaft of the pool hook in a pool hook.

FIG. 6 is a partial elevational side view of the lower bend of the pool hook of the invention having a round cross-section in which the end surface is generally perpendicular to the curve of the lower end.

FIG. 7 is a perspective view of pool hooks of the invention hanging on a vertical surface with the lower bends oriented in the same direction.

FIG. 8 is a perspective view of two pool hooks of the invention hanging on a fence with the lower bends oriented in opposite directions.

### DETAILED DESCRIPTION OF THE INVENTION AND PREFERRED EMBODIMENTS THEREOF

The present invention provides an inexpensive lightweight swimming pool hook having a first end with a short hook and a second end with an extended hook. As used herein the first end is termed the “lower bend”, and is the end that may be used to hook on to a pool accessory such as a skimmer cover (also called a skimmer lid). While either end of the pool hook may be used to pull items in, such as out of the water depending on the size and shape of the items and the user's preference, and while the pool hook may be inverted so that the lower bend is upward for a particular use, preferably the lower bend of the pool hook of the invention is used to pull up skimmer covers, as well as skimmer baskets, as well as cleaner hoses and the like that are in the pool water. In addition, skimmer baskets typically have a bar going cross the top, which may be engaged by the lower bend to remove or replace the whole skimmer basket. Either end may also be used to push down leaves in the skimmer or for other purposes as desired by the pool servicing personnel. The second end of the pool hook is termed the “upper bend” when aligned for use in removing skimmer covers and the like, and is typically the end that is held in the hand of the pool servicing personnel. It may of course by used to pull in leaves or other items floating in the water that may be more easily moved with that end.

While the pool hook of the invention is designed particularly for use in removing pool skimmer covers, other possible uses include picking up other lawn items, helping remove sprinkler system caps and the like.

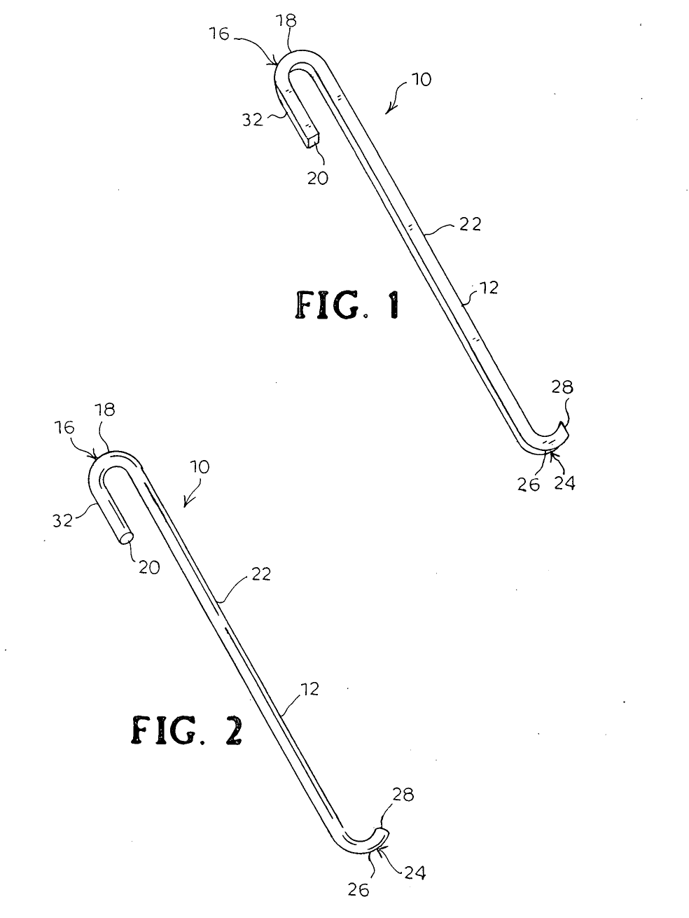

Referring in greater detail to the figures, the pool hook 10 of the invention (FIGS. 1-3) is preferably made of a rod 12 formed of a one-piece, integral piece of plastic, such as plexiglas. The plastic used may be clear or colored as is desired. This material must be malleable enough to be formed into a rod and strong enough for routine use in engaging and lifting the skimmer covers and skimmer baskets. Other plastic materials known in the art which may be formed into a sturdy lightweight hook may be used, including but not limited to appropriately treated and formed acrylonitrile-butadiene-styrene, chlorinated polyvinyl chloride, ethylene-chlorotrifluorethylene, ethylene-tetrafluoroethylene, ethylene-vinyl acetate, fluorinated ethylene propylene, high density polyethylene, liquid crystal polymer, low density polyethylene, linear low density polyethylene, medium density polyethylene, polytetrafluoroethylene-perfluoromethylvinylether, polyamide (nylon), polyaryletherketone, polyarylethersulfone, polyamide-imide, polyarylate, polyarylsulfone, polybutylene, polybutylene terephthalate, polycarbonate, polycyclohexylenedimethylene terephthalate, PTA and CHDM copolyester, polychlorotrifluoroethylene, glycol-modified PCT copolymer, polyethylene, polyetheretherketone, polyetherimide, polyethersulfone, polyethylene terephthalate, glycol modified polyester terephthalate, perfluoroalkoxy, polyimide, polymethyl methacrylate (acrylic), polymethyl pentene, polyoxymethylene (acetal), polypropylene, polyphenylene ether (modified), polyphenylene sulfide, polystyrene, polysulfone, polytetrafluoroethylene, polythramethylene terephthalate, polyurethane, polyvinyl chloride, polyvinylidene fluoride, polyvinyl fluoride, styrene acrylonitrile, styrene maleic anhydride and polycarbonate, thermoplastic elastomer, and ultra high molecular weight polyethylene. The pool hook of the invention may be modified as known by those of ordinary skill in the art for related uses and the appropriate plastic materials chosen for these uses. For example, for some uses, plastics that are more or less strong may be appropriate. While the pool hook may be made of other materials such as metals, use of any material that is heavy, weak, reactive with water, conductive, or can rust or corrode is strongly discouraged.

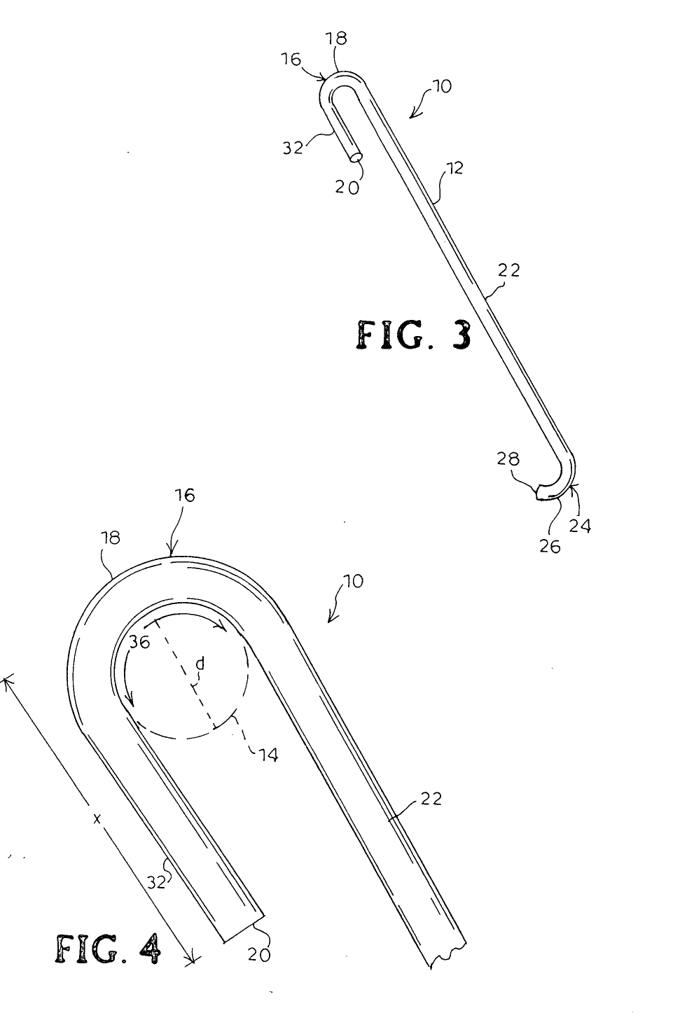

The selected plastic material such as plexiglas is formed or cut as is known in the art to form the rod 12 as shown in FIGS. 1-3. Preferably the rod 12 is either square (FIG. 1) or circular (FIGS. 2-3) in cross-section. The variations in bend dimensions and end cut angles discussed hereinbelow are shown arbitrarily in the figures herein on either round or square rods, it being understood that particular rod shapes may be made in either round or square cross-section without departing from the invention herein. The preferred cross-sectional dimensions of the rod 12 are 7/16 inch× 7/16 inch for the square elongated rod and 7/16 inch radius for the circular elongated rod. While either a round or square cross-section for the rod may be used, a rod having a circular cross-section is smoother to hold and use, while a rod having a square cross-section have a sturdier construction that is more useful for many purposes.

Preferably the rod 12 forming the pool hook 10 is cut to length, which is preferably at least about 27 inches, and most preferably about 27½ inches. Lengths of the chosen rod material are cut to the desired length and then formed as discussed herein. When the pool hook 10 is in its finished form with bends at both ends, this allows an effective working length of preferably about 21¾ inches, which is sufficient for most people to use without requiring them to stoop over to remove the skimmer cover but is not too long as to be unwieldy. This length also is short enough that the pool hook 10 can conveniently be carried or stored when not in use in a standard plastic bucket without falling out of the bucket. Different lengths may be made for very short or very tall people or for other uses without departing from the invention herein.

The ends of the rod 12 are then and then bent with a mold as known in the art and as discussed below. The direction of bend of the two ends in either the circular or square cross-section rods may be in the same (e.g., FIG. 3) or in opposite (FIGS. 1-2) directions without departing from the invention herein. Other than these two bends in the rod, the remainder of the rod 12 is most preferably a straight linear shaft 22 and is not bent.

The preferred method of formation of the bends at each end is to heat the plastic of the rod 12 at or near the ends and bend a portion of each of the ends of the rod 12 around a circular shaping rod 14 as is known in the art. Preferably the diameter of the shaping rod 14, and thus of the inner side of each bend, is 1½ inches. Thus, each of the two bends has a portion that is circularly arched and has an inner circular diameter that is the same as the diameter of the shaping rod 14 or fits tightly over a rod having the diameter of the shaping rod 14. A smaller diameter for the lower bend 24 generally results in too tight a fit for the lower bend 24 in the holes typically provided on skimmer covers so that it is difficult to engage and disengage the pool hook 10 from the skimmer cover. A larger diameter for the lower bend 24 generally makes it more difficult to grab or hold the skimmer cover on the pool hook 10.

As shown in FIG. 4, the upper arched portion 36 extends between the shaft 22 and a handle extension 32 which in turn extends parallel or close to parallel to the shaft 22 so that the distance x between the uppermost portion 18 of the upper bend 16 and the upper tip 20 of the rod is preferably about 4 inches. The dashed circle in FIG. 4 represents the position and shape of the shaping rod 14 (e.g., a dowel) during formation of the upper bend 16. Preferably for use as the handle of the pool hook 10, this process results in the upper tip 20 being slightly closer than 1½ inches from the shaft 22 (e.g., about 1⅛ inch) as is shown in FIG. 4 so that the upper bend 16 forms a more comfortable handle for the user; however, the two sides of the upper bend may optionally be parallel as shown in FIGS. 1-3.

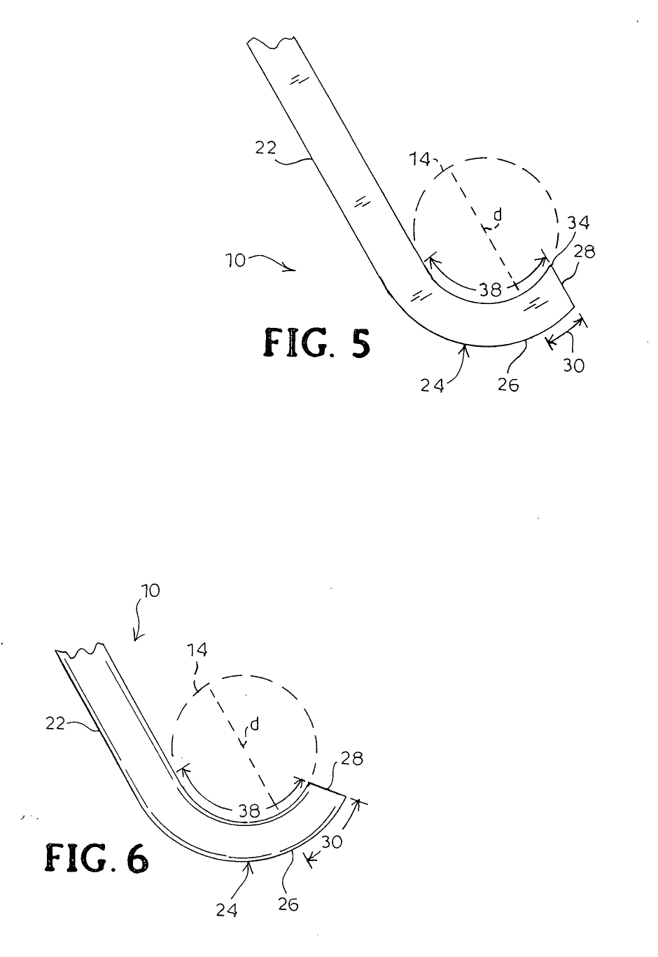

The lower bend 24 (FIGS. 5-6) is also preferably formed around a circular shaping rod 14, but the lower tip 28 only partially extends around the shaping rod so that the lower arched portion 38 is shorter than the upper arched portion 36 and extends to the lower tip 28. As shown in these figures if an imaginary diameter line d is drawn through the shaping rod 14 parallel to the shaft 22 and extending to the lowest portion 26 of the lower bend 24, the lower tip 28 preferably only extends as a short extension 30 (e.g., about ½ inch past this diameter line d. Extension 30 may optionally be made to be slightly longer, particularly if the structure of particular pool skimmers makes such a variation more suitable for engagement and disengagement with these pool skimmers.

Preferably the angle of cut of the upper tip 20 is perpendicular to the axis of the rod 12 at the upper tip 20 as shown in FIG. 4 for both the square and circular cross-section pool hooks. The angle of the cut of the lower tip 28, however, may either be perpendicular to the axis of the rod at the point of the cut as shown in FIG. 6 for the circular cross-section rod or parallel to the axis of the shaft 22 as shown in FIG. 5 for the square cross-section rod. The latter type of cut provides more of a protruding hook-tip 34 which allows for better engagement of the skimmer cover. Too much of a hook, however, may make it difficult to disengage the hook from the cover or other item. Variations in the angle of cut of the upper tip 20 and lower tip 28 may be varied for particular purposes so long as is known in the art.

In the preferred use of the pool hook of the invention, the pool water flow is shut off before removing the skimmer cover to reduce suction pressure on the skimmer cover, which may be more of a problem when there is only one skimmer for a pool. Then, the pool servicing person grasps the upper bend 16 of the pool hook 10 and inserts the lower tip 28 of the lower bend 24 in the hole of the skimmer cover. The pool hook 10 is then lifted upward to remove the skimmer cover and allow cleaning or other servicing of the skimmer. The pool hook may be used to put the skimmer cover back in place, or this may be done by hand.

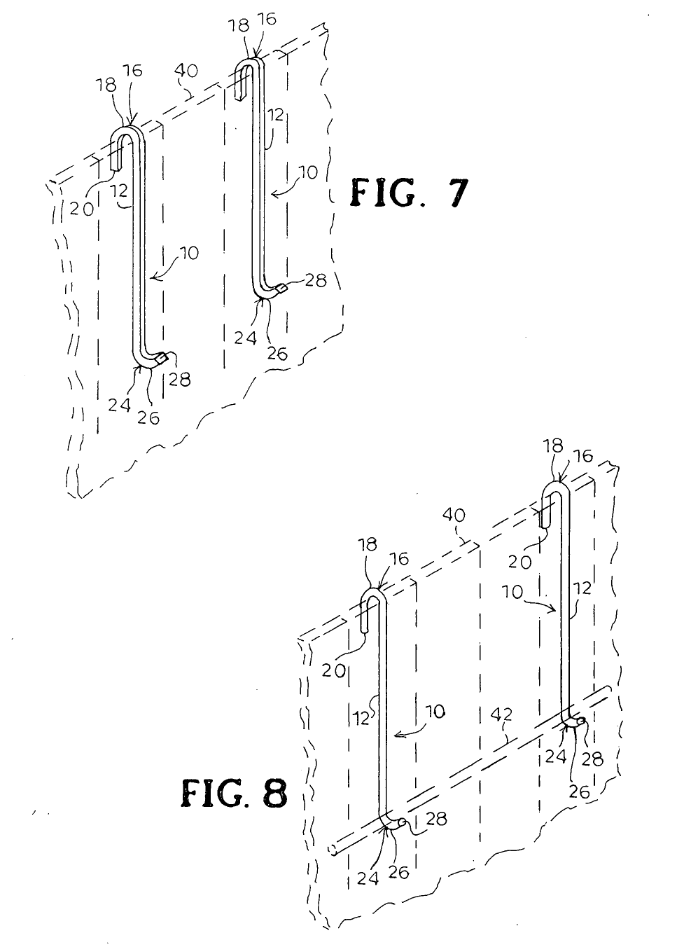

As mentioned above, the pool hook 10 of the invention may optionally be used for other purposes, such as reaching hard-to-reach places to retrieve an object, such as a cord or cleaner hose, or hang on a fence 40 (FIGS. 7-8) so that other items such as a telescopic pole 42, net, pool brush and the like may be hung on the pool hooks. Pool hooks 10 used in this manner may be hung with their upper bends 16 over the fence 40 or other structure and their lower bends 24 oriented in the same (FIG. 7) or opposite (FIG. 8) directions.

Other uses for the pool hook 10 of the invention include as a mixer for chemicals in a pail for addition to the pool water, reaching hard-to-reach areas in vehicles or buildings, such as behind furniture, reaching for floaters in a pool.

While the invention has been described with reference to specific embodiments, it will be appreciated that numerous variations, modifications, and embodiments are possible, and accordingly, all such variations, modifications, and embodiments are to be regarded as being within the spirit and scope of the invention.

What is claimed is:

1. A pool hook comprising a one-piece rod forming a shaft and having an upper bend and a lower bend; wherein the upper bend and the lower bend each have a circularly arched portion, wherein the upper bend forms a handle having a handle extension extending parallel or nearly parallel to the shaft between the upper arched portion and an upper tip, and wherein the lower bend has a short extension that is part of the lower arched portion for hooking a pool skimmer cover.

2. The pool hook of claim 1, wherein the circularly arched portions have a diameter of about 1½ inches.

3. The pool hook of claim 1, wherein the rod has a circular cross-section.

4. The pool hook of claim 1, wherein the rod has a square cross-section.

5. The pool hook of claim 1, wherein the upper tip is perpendicular to the handle extension.

6. The pool hook of claim 1, wherein the lower bend has a lower tip that is perpendicular to the arched portion.

7. The pool hook of claim 1, wherein the lower bend has a lower tip that is perpendicular to the shaft.

8. The pool hook of claim 1, wherein the upper tip of the handle extension is slightly angled toward the shaft so that it is not parallel to the shaft.

9. The pool hook of claim 1, wherein the short extension is about ½ inch long.
